(19) United States
(12) Patent Application Publication
(10) Pub. No.: US 2024/0328891 A1
(43) Pub. Date: Oct. 3, 2024

(54) A DAMAGE DETECTION SYSTEM

(71) Applicant: THREE SMITH GROUP LIMITED, Elland, West Yorkshire (GB)

(72) Inventors: David Edgar, Elland, West Yorkshire (GB); Matthew Wroe, Elland, West Yorkshire (GB); Milos Bozic, Elland, West Yorkshire (GB)

(73) Assignee: THREE SMITH GROUP LIMITED, Elland, West Yorkshire (GB)

(21) Appl. No.: 18/579,073

(22) PCT Filed: Jul. 12, 2022
(86) PCT No.: PCT/GB2022/051795

§ 371 Date: Jan. 12, 2024

(30) Foreign Application Priority Data
Jul. 15, 2021 (GB) 2110194.4

(51) Int. Cl. G01M 5/00

(52) U.S. Cl. CPC G01M 5/0025; G01M 5/0033

(57) ABSTRACT

A damage detection system, comprising: an elongate structure, wherein the elongate structure comprises a safety structure or a racking limb; a radiation emitter configured to emit a radiation signal internally to, and along a length of, the elongate structure; a radiation sensor configured to receive the radiation signal and output a sensing signal in response; and a controller configured to: receive the sensing signal from the radiation sensor; determine a damage status of the elongate structure based on the sensing signal; and output a damage signal representative of the damage status.

### FIELD

The present disclosure relates to a damage detection system for an elongate structure based on the emission and receipt of a radiation signal and a method of monitoring a condition of a safety structure or a racking limb.

### SUMMARY

According to a first aspect of the present disclosure there is provided a damage detection system, comprising:
an elongate structure, wherein the elongate structure is, or comprises, a safety structure or a racking limb;
a radiation emitter configured to emit a radiation signal internally to, and along a length of, the elongate structure;
a radiation sensor configured to receive the radiation signal and output a sensing signal in response; and
a controller configured to:
   receive the sensing signal from the radiation sensor;
   determine a damage status of the elongate structure based on the sensing signal; and
   output a damage signal representative of the damage status.

The radiation sensor may be co-located with the radiation emitter and the radiation sensor may be configured to receive the radiation signal as a reflected radiation signal.

The radiation sensor may be configured to receive the reflected radiation signal from a reference reflecting surface when the elongate structure is in an undamaged state.

The reference reflecting surface may comprise any one or more of:
a surface of a reflector positioned along a length of the elongate structure;
an end surface of the elongate structure; and
a surface of a second structure abutted to an end of the elongate structure.

The reference reflecting surface may be a diffuse reflecting surface or a specular reflecting surface.

The radiation emitter and/or radiation sensor may be positioned at a first end of the elongate structure.

The reference reflecting surface may be positioned at a second end of the elongate structure.

The damage detection system may comprise a plurality of reference reflecting surfaces corresponding to a plurality of reference reflectors positioned on an internal sidewall along a length of the elongate structure.

The damage detection system may comprise a plurality of radiation emitter and radiation sensor pairs positioned successively along the length of the elongate structure. Each radiation sensor may be co-located with its corresponding radiation emitter. Each radiation sensor may be configured to receive a radiation signal emitted by the corresponding emitter and reflected from a corresponding reference reflection surface. The controller may be configured to receive a sensing signal from each of the radiation sensors and determine the damage status based on the sensing signals.

The radiation emitter and the radiation sensor may be separated by an axial distance along an axis of the elongate structure with a sensing surface of the radiation sensor facing the radiation emitter.

The radiation emitter may be positioned at a first end of the elongate structure. The radiation sensor may be positioned at a second end of the elongate structure.

The damage detection system may comprise a plurality of radiation emitter and radiation sensor pairs positioned successively along the length of the elongate structure. Each radiation sensor may be spatially separated from its corresponding radiation emitter along an axis of the elongate structure. Each radiation sensor may be configured to receive a radiation signal emitted by the corresponding radiation emitter. The controller may be configured to receive a sensing signal from each of the radiation sensors and determine the damage status based on the sensing signals.

The controller may be further configured to:
receive trigger signalling; and
selectively activate the radiation emitter and radiation sensor and receive the sensing signal in response to the trigger signalling.

The trigger signalling may comprise a periodic trigger signal for selectively activating the damage detection system according to a monitoring schedule.

The trigger signalling may comprise an on-demand signal from a trigger sensor responsive to:
motion of an object within a predetermined radius of the elongate structure; and/or
impact of an object with the elongate structure.

The radiation emitter may comprise an optical radiation emitter. The radiation sensor may comprise an optical radiation sensor.

The radiation emitter may comprise a laser source.

The radiation emitter may comprise an ultrasound source. The radiation sensor may comprise an ultrasound sensor.

The radiation sensor may comprise a radiation sensor array of a plurality of pixels.

Each pixel may be configured to receive the radiation signal from a sub-volume of the elongate structure.

The radiation emitter may be configured to emit the radiation signal along a cavity of the elongate structure.

The damage status may comprise one or more of:
a damage state of the elongate structure;
a level of damage to the elongate structure;
a lateral position of a damage site;
an axial position of a damage site; and/or
an assembly status of the elongate structure.

The damage state may comprise a value of damaged or not damaged.

The controller may be configured to determine the damage status based on a change in power level characteristics and/or temporal characteristics of the sensing signal.

The controller may be configured to determine the damage status based on a signal difference between the sensing signal and a reference sensing signal corresponding to the sensing signal when the elongate structure is in an assembled and undamaged state.

The reference sensing signal may correspond to a reflection of the radiation signal from the reference reflecting surface.

The controller may be configured to receive the reference sensing signal as part of a calibration routine.

The controller may be configured to determine the damage status based on whether the signal difference exceeds one or more condition thresholds.

The controller may be configured to determine an axial position of a damage site based on time of flight characteristics of the sensing signal.

Each pixel may be configured to output a sub-sensing signal based on a received radiation signal. The controller may be configured to:
determine a level of damage based on a number of sub-sensing signals that exhibit a change in power and/or temporal characteristics exceeding a detection threshold; and/or
determine a lateral position of a damage site based on which sub-sensing signals exhibit a change in power and/or temporal characteristics exceeding a detection threshold.

The damage detection system may further comprise an audible and/or visual indicator. The controller may be configured to output the damage signal by activating the audible and/or visual indicator.

The controller may be configured to output the damage signal by transmitting the damage signal to an external device.

The controller may be co-located with the radiation sensor. The controller may be coupled to the radiation sensor via a network. The controller may comprise a plurality of processors distributed between being co-located with the radiation sensor or coupled to the radiation sensor via the network.

The damage detection system may further comprise:
a plurality of radiation emitters, each radiation emitter configured to emit a radiation signal internally to, and along a length of, a corresponding elongate structure;
a plurality of radiation sensors each configured to receive a corresponding radiation signal and output a corresponding sensing signal;
a plurality of transceivers each coupled to a radiation sensor; and
a server configured to communicate with each of the plurality of transceivers.

According to a second aspect of the present disclosure, there is provided a method of monitoring a condition of a safety structure or a racking limb, comprising:
emitting a radiation signal internally to, and along a length of, the elongate structure;
receiving the radiation signal and outputting a sensing signal in response;
determining a damage status of the elongate structure based on the sensing signal; and
outputting a damage signal representative of the damage status.

According to a third aspect of the present disclosure, there is provided a damage detection system, comprising:
a housing configured to couple to an elongate structure, wherein the elongate structure comprises a safety structure or a racking limb, the housing including:
   a radiation emitter configured to emit a radiation signal internally to, and along a length of, the elongate structure; and
   a radiation sensor configured to receive the radiation signal and output a sensing signal in response; and
a controller configured to:
   receive the sensing signal from the radiation sensor;
   determine a damage status of the elongate structure based on the sensing signal; and
   output a damage signal representative of the damage status.

There may be provided a computer program, which when run on a computer, causes the computer to configure any apparatus, including a circuit, controller, converter, or device disclosed herein or perform one or more steps of any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform one or more steps of any method disclosed herein.

### BRIEF DESCRIPTION OF THE DRAWINGS

One or more embodiments will now be described by way of example only with reference to the accompanying drawings in which:

FIG. 1A illustrates a damage detection system, according to an embodiment of the present disclosure, for a structure that is in an undamaged state;

FIG. 18 illustrates the damage detection system of FIG. 1A where the structure is in a first damaged state;

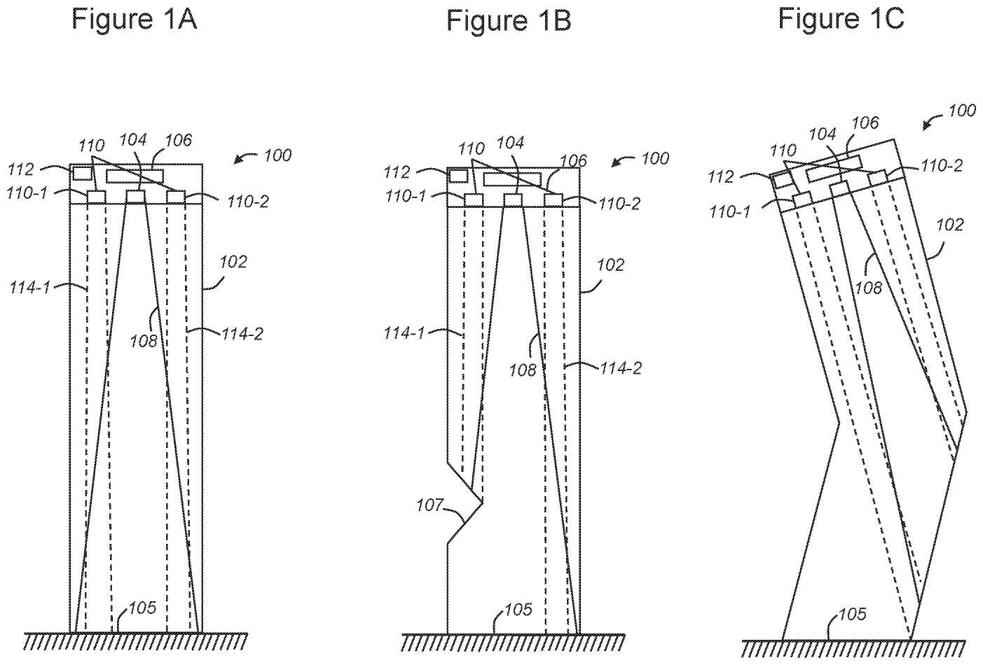

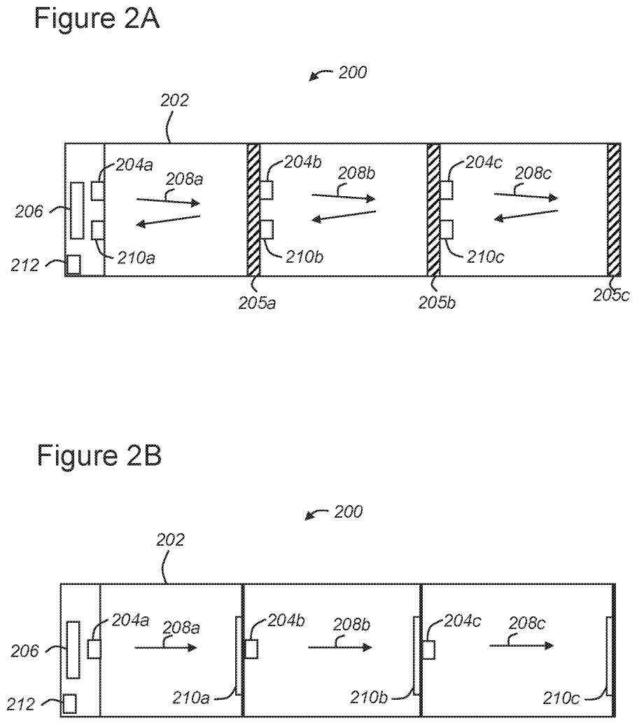

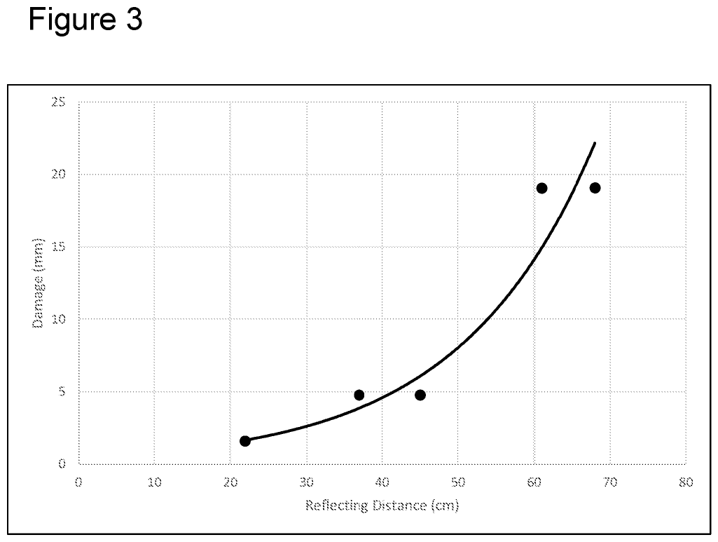

FIG. 1C illustrates the damage detection system of FIG. 1A where the structure is in a second damaged state;

FIG. 2A illustrates another damage detection system according to an embodiment of the present disclosure;

FIG. 2B illustrates a further damage detection system according to an embodiment of the present disclosure;

FIG. 3 illustrates experimental data for a damage detection structure according to an embodiment of the present disclosure;

FIG. 4A illustrates a networked damage detection system according to an embodiment of the present disclosure;

FIG. 4B illustrates a further networked damage detection system according to an embodiment of the present disclosure; and

FIG. 5 illustrates a method of monitoring a condition of a safety structure or a racking limb according to an embodiment of the present disclosure.

### DETAILED DESCRIPTION

Many structures can pose a safety hazard when damaged, for example bridges, buildings and equipment. One damage pathway is a vehicle collision with the structure. For example, in a factory or warehouse environment, vehicles may be required to move within confined spaces and in close proximity to valuable goods and personnel. In a warehouse, forklift trucks (FLTs) may pass between isles of racking or shelving that contain valuable stock. A FLT may have to perform tight turns and manoeuvres to load and unload stock from the racking. Even a skilled driver may accidently collide with racking causing damage and creating a potential safety hazard from the racking collapsing, particularly if the collision is not detected or goes unreported.

Collision sensors on structures can alleviate this risk by detecting and reporting collisions. However, collision sensors may generate many false alarms from non-damaging collisions resulting from a pedestrian brushing past the structure or other minor vibration events.

The damage detection system disclosed herein is suitable for use with elongate structures, such as posts, barriers or racking pieces, for which it may be advantageous to monitor the structural integrity of the structure and/or collisions or impacts with the structure.

FIGS. 1A to 1C illustrate a damage detection system 100 according to an embodiment of the present disclosure. The system 100 comprises a radiation emitter 104 coupled to an elongate structure 102. The radiation emitter 104 is configured to emit a radiation signal 108 internally to, and along a length of, the elongate structure 102. For example, the radiation emitter 104 may emit the radiation signal 108 through a cavity extending internally along a length of the elongate structure 102. The system 100 further comprises a radiation sensor 110 configured to receive the radiation signal 108. The radiation sensor 110 may receive the radiation signal 108 following a reflection of the radiation signal from one or more surfaces. The radiation sensor 110 is configured to output a sensing signal in response to receiving the radiation signal 108. The system 100 further comprises a controller 106 configured to receive the sensing signal from the radiation sensor 110, determine a damage status (or condition) of the elongate structure based on the sensing signal and output a damage signal representative of the damage status.

The elongate structure 102 comprises a safety structure or a racking limb. In the context of the present disclosure, a racking limb will be understood to be any elongate component of a racking unit, shelving unit or the like, such as rack legs, rack posts, rack cross-bars, shelves and the like. In the context of the present disclosure, a safety structure will be understood to be a physical structure that protects another structure or protects an area from intrusion or collision, including safety barrier systems and component parts thereof (e.g. barriers, posts), safety fencing, bollards, railing, guarding and similar safety structures known in the art. The safety structure may include a polymer safety structure that can provide a resilient safety structure. Alternatively, the safety structure may comprise metallic or metal alloy safety structures or any other suitable material. The system 100 optionally comprises the elongate structure 102 itself.

The system 100 can advantageously use the radiation emitter 104 and sensor 110 to monitor changes in the received radiation signal 108 and determine a corresponding structural change in the elongate structure 102 from a normal undamaged state (FIG. 1A) to a damaged state (FIGS. 1B and 1C) or a disassembled state (not shown). As described further below, the controller 106 may output a damage signal representative of the sensing signal and the determined damage status of the elongate structure 102. The controller 106 may output the damage signal via an output signal generator 112.

The damage detection system 100 can advantageously monitor the condition of the elongate structure 102 and detect damage that may otherwise go unnoticed or undetected. The damage detection system 100 can also advantageously complement a collision sensor system to determine whether a collision event is associated with damage to the monitored structure.

In this example, the radiation emitter 104 is co-located with the radiation sensor 110 at a first end of the elongate structure 102. The term “co-located” will be understood to mean located at substantially the same position, for example in the same plane along a length of the elongate structure, or proximal to or adjacent to. By co-locating the radiation sensor 110 with the radiation emitter 104, the radiation sensor 110 is configured to receive the radiation signal 108 in reflection. A sensing surface of the radiation sensor 110 may face in the same direction as an emitting side of the radiation emitter 104. The radiation signal 108 may reflect from a reference reflecting surface 105 when the structure 102 is in the normal undamaged state. The radiation signal 108 may reflect from a second end of the elongate structure 108. In the example of FIG. 1A, the reference reflecting surface 105 comprises a ground surface to which the second end of the elongate structure 102 is fixed. In other examples, the reference reflecting surface 105 may comprise a reflector positioned along a length of the elongate structure with a reflecting surface facing the radiation emitter 104. The radiation signal 108 may reflect off the reflector back towards the radiation sensor 110. Following damage, the radiation signal 108 may reflect (diffuse or specular) from a surface other than the reference reflecting surface 105, such as from a sidewall surface of the elongate structure (as illustrated in FIGS. 1A and 1B).

In other examples, the radiation emitter 104 and radiation sensor 110 may be separated by an axial distance along an axis of the elongate structure 102. In such examples, the radiation sensor 110 is configured to receive the radiation signal 108 in transmission. A sensing surface of the radiation sensor 110 may be spaced apart from and face towards the radiation emitter 104. In some examples, the radiation emitter 104 may be positioned at a first end of the elongate structure 102 and the radiation sensor 110 may be positioned at a second end of the elongate structure 102. In other examples, the radiation emitter 104 and/or radiation sensor 110 may be positioned at any point along the axis of the elongate structure 102.

FIGS. 2A and 2B illustrate further damage detection systems 200 comprising multiple radiation and emitter pairs positioned successively along a length of the elongate structure 202. Each pair may be coupled to the controller 206 which may receive a corresponding sensing signal from each radiation receiver via wired or wireless means. Including a plurality of radiation emitter/sensor pairs can extend a detection range of the damage detection system 200, which can be particularly advantageous for long elongate structures 202.

As illustrated in FIG. 2A, each radiation sensor 210a, 210b, 210c may be co-located with its corresponding radiation emitter 204a, 204b, 204c and the system 200 may include a plurality of corresponding reference reflectors 205a, 205b, 205c for reflecting the radiation signal 208a, 208b, 208c from the radiation emitter 204a, 204b, 204c back towards the corresponding radiation sensor 210a, 210b, 210c. The reference reflectors 205a, 2056, 205c are separated from the corresponding emitter-sensor pair along the axis of the elongate structure 202 with a reference reflecting surface facing towards the emitter sensor pair. As illustrated, an opposite surface of the reflector may be used for mounting an adjacent emitter sensor pair. In this example, each reference reflector 205a, 205b, 205c and corresponding radiation emitter and sensor pair may define a damage detection sub-module measuring radiation signals in reflection.

Alternatively, as illustrated in FIG. 2B, each radiation sensor 210a, 210b, 210c may be separated from its corresponding radiation emitter 204a, 204b, 204c along the axis of the elongated structure 202. In this way, each radiation emitter and sensor pair may define a damage detection sub-module measuring radiation signals in transmission.

Returning to FIG. 1, further features of the disclosure will be described in relation to a system 100 with a single radiation emitter 104 and radiation sensor 110 operating in reflection. However, it will be appreciated that the concepts apply equally to a system operating in transmission and the multiple emitter-sensor pairs embodiments of FIGS. 2A and 2B.

The radiation emitter 104 may comprise any electromagnetic radiation source or any acoustic radiation source. The radiation signal 108 corresponds to radiation emitted by the radiation emitter and should be interpreted accordingly. The radiation sensor comprises a radiation detector corresponding to the specific radiation emitter.

In this example, the radiation emitter 104 comprises a laser source. The laser source 104 may comprise a laser diode, a laser edge-emitting diode, a vertical cavity surface emitting laser or other suitable laser sources known in the art. In other examples, the radiation emitter 104 could comprise a different optical source such as a light emitting diode (LED). The laser source (or LED) may be configured to emit an optical radiation signal 108 with a wavelength in the ultra-violet, visible or infra-red portion of the electromagnetic radiation spectrum.

As illustrated, the radiation emitter 104 may emit the radiation signal 108 as a divergent radiation beam. In other examples, the radiation emitter 104 may be coupled to a lensing component (such as an optical lens) and emit the radiation signal as a substantially collimated radiation beam. A diameter of the substantially collimated radiation beam may be substantially equal to an inner diameter (cavity diameter) of the elongate structure 102. A collimated radiation beam may advantageously illuminate substantially the whole volume of the cavity of the elongate structure 102.

In this example, the radiation sensor 110 comprises an optical sensor configured to detect the optical radiation signal 108. The optical sensor may have a wavelength detection range encompassing the wavelength of the optical radiation signal 108.

The radiation sensor 110 may comprise a field of view defining a detection cone from within which the sensor 110 can receive the radiation signal 108. As illustrated, the radiation sensor 110 may comprise a plurality of sub-sensors or pixels 110-1, 110-2. Each pixel 110-1, 110-2 may have a corresponding pixel field of view 114-1, 114-2. The combination of the pixel field of views 114-1, 114-2 may be considered as defining the field of view of the radiation sensor 110. The pixel field of view 114-1, 114-2 may comprise a narrow cone angle such that each pixel 110-1, 110-2 receives the radiation signal 108 from a substantially columnar sub-volume of the elongate structure 102. In this way, each pixel 110-1, 110-2 may monitor (and detect damage in) a particular sub volume of the elongate structure and the radiation sensor 110 can provide a spatially resolved sensing signal.

In some examples, the radiation sensor 110 may comprise a multi-pixel sensor array with a wide field of view. A lensing component (such as an optical lens) may be coupled with the radiation sensor 110 such that the multi-pixel sensor is configured to receive the radiation signal 108 from a volume corresponding to substantially the whole internal volume of the elongate structure 102. In this way, the radiation sensor 110 may image the cross-section of the cavity of the elongate structure and each pixel may monitor a columnar volume of the elongate structure. The lensing component may comprise the same lensing component for providing the collimated radiation beam.

Turning to FIG. 1A, illustrating the elongate structure 102 in a normal undamaged state, the radiation signal 108 is reflected from the reflecting surface 105 back towards the radiation sensor 110. The system 100 may include a reference reflector, comprising the reference reflecting surface 105, axially separated from, and reflecting the radiation signal 108 back towards, the radiation emitter 104 with the reflecting surface 105 facing towards the radiation sensor 110. The reference reflector may comprise a simple reference reflecting surface 105 (for example a dielectric or metallic mirror for an optical radiation signal, or a high-density solid for an ultrasonic radiation signal) or may comprise a multi-surface reflector such as a retro-reflector.

In some examples, the reference reflecting surface 105 may be a polished reflecting surface provide specular reflection of the radiation signal 108. An advantage of a specular reference reflecting surface 105 is that the magnitude of the reflected radiation signal can be higher providing a longer detection range. In addition, the possible return paths of the reflected radiation signal 108 may be limited providing better temporal resolution on the received radiation signal 108.

In other examples, the reference reflecting surface 105 may comprise a diffuse reflecting surface, such as an unpolished surface. In some examples, the system 100 may not comprise a separate reference reflector and the reference reflecting surface 105 may be provided by an end surface of the elongate structure 102 or by a surface of an adjacent structure such as the ground, as illustrated. Such reference reflecting surfaces 105 may provide diffuse and/or specular reflections.

In some examples, an internal sidewall surface of the elongate structure (a surface of the cavity) may comprise a diffuse (unpolished) reflective surface or a specular (polished) reflective surface. In some examples, the system may comprise a plurality of reference reflecting surfaces corresponding to a plurality of reference reflectors or markers positioned on the internal sidewall of the elongate structure. For example, a series of reference reflectors may be positioned on the internal sidewall at a range of positions along the length of the elongate structure 102. The plurality of reference reflectors may be positioned periodically along the length or a-periodically to avoid higher harmonic effects in the temporal characteristics of the received radiation signal. The reference reflectors may comprise reflecting stickers, reflecting protrusions and the like. The reference reflectors may comprise retro-reflectors such as retro-reflecting stickers. The plurality of reference reflectors can provide a signature reference signal.

Each reflector may correspond to a sub-component of the reference signal. As discussed below, the controller 106 can determine the damage status based on a difference between the reflected radiation signal and the reference signal. For example, any damage to the elongate structure 102 may result in a change in the radiation signal reflected by one or more of the plurality of reflectors. The controller 106 may determine the structure to be damaged if changes in the reflected radiation signal exceed a damage detection threshold. In some examples, the controller 106 may determine a location of a damage site based on (temporal or power) changes in the reflected radiation signal attributable to a specific one of the plurality of reference reflectors. For example, a change in a specific sub-component of the reflected signal.

As will be discussed further below, the radiation sensor 110 and controller 106 may monitor the temporal characteristics and/or power characteristics of the received radiation signal. The use of specular or diffuse surfaces in the path of the radiation signal may depend on a particular detection mechanism of the system 100. For example, a specular reference reflecting surface 105 may be advantageous when monitoring power characteristics as the specular reflection can provide a high-power reference signal in the normal undamaged state. The controller 106 can then detect damage to the elongate structure (such as in FIG. 1B or 1C) as an attenuation of the reference signal. However, as will be discussed below, the system 100 can monitor the temporal characteristics of the received radiation signal received from a damage site 107 to determine a time of flight of the radiation signal and the corresponding location of damage. The radiation sensor 110 may rely on receiving a diffuse reflection from the damage site 107 because a path of a specular reflection from the damage site 107 may not return directly to the radiation sensor 110. In such examples, a diffuse reference reflecting surface 105 may be advantageous to avoid the reference signal drowning out the diffuse reflection from the damage site 107. Example systems that monitor power and temporal characteristics may utilise diffuse reflections and may avoid the inclusion of any polished surfaces.

The radiation signal 108 received by the radiation sensor 110 may change in response to damage to the elongate structure 102 resulting in a corresponding change to the sensing signal. The sensing signal may be a voltage signal with a voltage level corresponding to an optical power level of the received radiation signal. The controller 106 may determine the damage status of the elongate structure 102 based on the sensing signal and output the damage signal. For example, the controller 106 may determine the elongate structure 102 to be damaged in response to a change in the sensing signal greater than a detection threshold. The changes in the sensing signal may comprise changes in power characteristics and/or changes in temporal characteristics.

In some examples, the controller 106 may compare the sensing signal from the radiation sensor 110 to a reference sensing signal and determine the damage status based on a signal difference between the sensing signal and the reference sensing signal. The signal difference may comprise a difference or ratio in power or amplitude level and/or a difference in temporal characteristics such as phase or a pulse leading-edge time. The reference sensing signal may correspond to the sensing signal when the elongate structure 102 is the normal, undamaged configuration illustrated in FIG. 1A. The reference sensing signal may correspond to a reflection from the reference reflecting surface 105 (or plurality of reference reflecting surfaces).

The controller 106 may receive the reference sensing signal from the radiation sensor 110 as part of a calibration routine. The calibration routine may be performed by the controller 106 at any time including: a time of manufacture, a time of installation, a time of assembly, a time of re-assembly, a time of service and/or a time of relocation of the elongate structure 102.

The sensing signal may comprise sensing sub-signals corresponding to signals from each pixel 110-1, 110-2 of the radiation sensor 110. The controller 106 may determine the damage status of the structure 102 based on changes in any of the sensing sub-signals. Similarly, the reference sensing signal may comprise reference sensing sub-signals for comparison to each corresponding sensing sub-signal to determine a plurality of signal differences. It will be appreciated that in the preceding and following description, the functionality of the controller 106 in processing the sensing signal (and the signal difference) may equally apply to the processing of individual sensing-sub signals (and signal differences) and the controller 106 may determine the damage status of the elongate structure 102 based on the plurality of sensing sub signals. For example, the controller 106 may determine a damage site 107 based on which sensing sub-signals exhibit a change. Similarly, the controller 106 may determine a level of damage based on the number of sensing sub-signals that exhibit a change.

The controller 106 may determine the damage status of the elongate structure 102 by comparing the signal difference to one or more condition thresholds. In a first simple example, the controller 106 may determine a simple binary damage status of the elongate structure as damaged (or disassembled) or not damaged based respectively on whether or not the sensing signal difference exceeds the detection threshold. The detection threshold may correspond to a change in power level and/or a change in a temporal characteristic (phase, leading edge arrival time etc).

The controller 106 may determine the damage status of the elongate structure 102 by comparing a power level difference of the signal difference to one or more condition thresholds. The controller 106 may determine a quantitative level of damage based on a magnitude of the power level difference. In some examples, such as when the system 100 operates in reflection and the reference reflecting surface 105 comprises a diffuse surface, an increase in power level may indicate damage to the elongate structure 102. For example, damage may result in a reflection from polished sidewall surfaces or may result in a reflection from a diffuse sidewall surface but with a larger portion of the diffuse reflection falling within the field of view of the radiation sensor 110 due to the closer proximity of the damage site 107 to the radiation sensor 110. In some examples, such as when the system operates in transmission or when the system operates in reflection and the reference reflecting surface 105 comprises a polished surface, a decrease in power level may indicate damage to the elongate structure 102. For example, damage (such as in FIG. 1B or 1C) may at least partially occlude a radiation signal 108 measured in transmission or a specular reflection path to or from the polished reference reflection surface 105.

In examples with a multi-pixel radiation sensor 110, the controller 106 may determine a level of damage based on a number of sub-sensing signals with a signal difference greater than a detection threshold. The controller 106 may also determine a lateral position of damage based on which of the sub-sensing signals comprise a sensing difference greater than the detection threshold.

The controller 106 may determine the damage status of the elongate structure 102 based on the temporal characteristics of the sensing signal. In some examples, the controller 106 may determine the damage status of the elongate structure 102 based on changes in the temporal characteristics of the sensing signal relative to the reference sensing signal.

In some examples, the controller 106 may determine time of flight characteristics of the radiation signal/sensing signal. The time of flight characteristics may correspond to a time of flight of the radiation signal 108 or a path distance travelled by the radiation signal 108. The system 100 may determine the time of flight characteristics when the radiation emitter 104 and radiation sensor 110 are configured in a reflection mode of operation. The time of flight is based on the path distance divided by a speed of the signal. For an optical radiation emitter, the speed of the signal is the speed of light. The system 100 may implement an optical based time of flight measurement using one of two approaches.

In a first a first approach, the radiation emitter 104 may comprise a pulsed laser source for outputting short laser pulses. As the speed of light is 30 cm/ns, the pulsed laser source may output pulses with a pulse duration ranging from 1 ps to 10 ns, to provide sufficient temporal resolution for structure lengths ranging from tens of cm to tens of metres. The radiation emitter 104 may emit the radiation signal as a train of laser pulses. The train of laser pulses may have any repetition rate suitable for the pulse duration. For example, the repetition rate may range from 1 Hz to 1 GHz. The radiation sensor 110 may detect the laser pulse and produce a sensing signal with a corresponding pulse duration. The controller 106 may monitor an arrival time of the pulse and determine a corresponding time of flight. For example, the controller 106 may provide a timing signal to the radiation emitter 104 to control the pulse emission time or may receive a timing signal from the radiation emitter 104 indicative of pulse emission time. The controller 106 may then compare the arrival time of the pulse with the emission time of the pulse to determine the time of flight of the radiation signal 108 and corresponding path distance.

In the second time of flight based approach, the radiation emitter 104 may comprise a continuous wave or quasi-continuous wave optical source. The controller 106 may modulate the radiation emitter 104 at a modulation frequency and monitor a phase of the received radiation signal to determine the path distance travelled by the radiation signal 108. In some examples, the modulation frequency may be selected such that a period of the modulation is greater than a maximum possible path distance travelled by the radiation signal 108. For example, when operating in reflection, the maximum possible path distance or reference path distance may be two times the distance from the radiation emitter 104 to the reference reflecting surface 105. In this way, any phase change between 0 and 2n will map to a corresponding path distance travelled/time of flight with a 1 to 1 relationship and avoid higher harmonic interference (phase changes greater than 2n). In some examples, the controller 106 may compare the sensing signal to one or more phase reference signals to determine the phase shift of the sensing signal and a corresponding round trip time or path distance. The path distance, d, travelled by the radiation signal 108 may be determined by the equation:

$$d = \frac{c}{{f}_{mod}} \frac{Δφ}{2 π}$$

where c is the speed of light in a vacuum, Δφ is the phase difference and f_{mod} is the modulation frequency. For a system 100 operating in reflection, the path distance may be divided by two to determine a corresponding distance to the reflecting surface, which may be the reference reflecting surface 105 or a damage site 107.

The controller 106 may monitor the time of flight characteristics (time of flight, path distance) to determine the damage status of the elongate structure 102. A reference path distance may correspond to the round-trip distance from the radiation emitter 104 to the reference reflecting surface 105 and back to the radiation sensor 110. In some examples, the controller 106 may determine the reference path distance based on the reference sensing signal. The controller 106 may determine the elongate structure 102 to be in the normal, undamaged state if the time of flight/path distance corresponds to the reference path distance. The controller 106 may determine the elongate structure 102 to be damaged if the time of flight/path distance corresponds to a distance less than reference path distance. The controller 106 may determine the damage status of the elongate structure 102 based on a signal difference, corresponding to a difference between the path distance and the reference path distance, exceeding a detection threshold. In some examples, the controller 106 may determine an axial position of the damage site 107 based on the time of flight or path distance.

In examples with a multi-pixel radiation sensor 110, the controller 106 may determine a level of damage based on a number of sub-sensing signals with a time of flight/path distance corresponding to a distance less than the reference path distance. The controller 106 may also determine a lateral position of damage based on which of the sub-sensing signals indicate a path distance less than the reference path distance.

FIG. 3 illustrates experimental data for a damage detection system according to an embodiment of the present disclosure. The data was acquired by mounting a time-of-flight radiation emitter and sensor module to an end of an elongate structure in the form of a racking leg. The module was a commercially available AFBR-S50-BAS time of flight sensor module from Broadcom. A vice was positioned in turn at several sites along the length of the racking leg to simulate damage. Data from the time of flight module was analysed to determine a change in path distance of the radiation signal and a corresponding distance to the source of reflection (damage site). The plot in FIG. 3 illustrates the amount of sidewall deformation (damage) required to detect a change in path distance corresponding to the damage site. The plot illustrates that the sensitivity of the system to damage can drop as the distance from the time of flight module to the damage site increases. However, the system was a proof of principle set-up and not optimised for collimation of source or pixel field of view.

Returning to FIG. 1, in some examples, the system 106 may monitor the elongate structure 102 on a continuous basis. In other examples, the controller 106 may selectively activate the radiation emitter 104 and receive a sensing signal on an on-demand basis in response to receiving a trigger signal. For example, the damage detection system 100 may reside in a sleep-mode to minimise energy consumption. In the sleep mode, all functionality of the system 100 may be disabled with the exception of the controller 106 listening for trigger signalling. The trigger signalling may comprise a periodic trigger signal according to a monitoring schedule. For example, the controller 106 may activate the radiation emitter 104 and radiation sensor 110 and receive a sensing signal at regular time intervals, for example, hourly, daily, weekly etc.

The system 100 may receive the trigger signalling as an on-demand signal from a trigger sensor. The trigger sensor may be responsive to: motion of an object within a predetermined radius of the elongate structure 102; and/or an impact of an object with the elongate structure 102. The controller 106 may activate the system 100 in response to the trigger signalling and determine a damage status of the structure 102 and provide a damage signal accordingly. In some examples, the system 100 may further comprise the trigger sensor. The trigger sensor may be a low-power device that can remain active during the sleep mode.

In some examples, the trigger sensor may comprise a mechanical sensor, for example a vibration or impact sensor such as an accelerometer. The mechanical sensor may form part of a collision sensor system. In some examples, the damage detection system 100 may form part of the collision sensor system. The mechanical sensor may detect vibration resulting from motion of an object (such as a passing vehicle) or from a collision of an object with the system 100 or the elongate structure 102. The mechanical sensor can detect a vibration/impact and, if a magnitude of the vibration is greater than a potential damage threshold, the controller 106 may receive the trigger signalling from the mechanical sensor and activate the damage detection system 100.

The controller 106 can sense any change in the sensing signal to determine if the detected vibration is associated with structural damage to the elongate structure 102. In this way, the system 100 can provide damage detection functionality for complementing a collision sensor. By determining the damage status of the elongate structure 102, the system 100 can distinguish vibrations at the elongate structure 102 resulting from potentially damaging collisions from those arising from low-risk vibrations such as a pedestrian brushing past the structure. Therefore, the system 100 can reduce false alarms in a collision sensor system.

In some examples, the trigger sensor may comprise an optical sensor for detecting motion. An optical sensor may comprise a passive infrared (PIR) sensor that can detect motion of an object within a predefined radius of the elongate structure 102. The controller 106 may receive signals from the PIR sensor and activate the damage detection system 100 in response to movement of an object within the predefined radius. In some examples, the controller 106 may receive a motion signal from the optical sensor and activate the damage detection system 100 following detection of a moving object. The controller 106 may continuously, or at regular intervals (for example multiple measurements per second), monitor any change in the sensing signal until the motion signal indicates that motion is no longer present. In this way, the damage detection system 100 can monitor the damage status of the elongate structure 102 throughout the entire motion event.

As outlined above, the controller 106 may determine the damage status of the structure 102 based on any power level or temporal changes in the sensing signal on a continuous basis or on a semi-continuous basis for a short interval based on trigger signalling. In examples where the controller 100 can determine a level of damage, the controller 106 may determine a sequence of sensing signals that can define a damage profile. In other words, the controller 106 may determine a transient damage profile based on a sequence of sensing signals from the radiation sensor. The controller 106 may store the transient damage profile or transmit it to the server or remote device for analysis of the collision event. Capturing a transient damage profile ensures that the maximum level of damage (as determined by a maximum number of attenuated pixels or a maximum number of pixels exhibiting change in time of flight characteristics) can be assessed against the one or more thresholds, even for elastic or partially elastic deformations in which the elongate structure 102 relaxes back to a less deformed state. The safety or integrity of the structure 102 can be assessed against regulatory requirements, safety specifications etc based on the maximum deformation undergone by the structure 102.

In some examples, the controller 106 may output the damage signal by way of the output signal generator 112. The output signal generator 112 may comprise an audible signal generator, such as a siren, or a visible signal generator such as a (flashing) light or a display screen displaying warning messages. In this way, the output signal generator 112 can alert pedestrians and vehicle drivers of any potential hazard arising from damage to the elongate structure 102. For example, a warning display may indicate a temporary vehicle speed limit or a no entry alert until the elongate structure 102 is inspected, repaired and/or replaced. The controller 106 may activate the output signal generator if the damage signal indicates that the elongate structure 102 is damaged.

In some examples, the output signal generator 112 may comprise a transmitter configured to transmit the damage signal and/or the sensing signal to an external device. For example, the transmitter may transmit the damage signal to a remote server, a remote device and/or a mobile device. In this way, the system 100 can alert a user to damage to the elongate structure and may indicate a potential requirement for inspection and/or repair. The damage signal may comprise a data signal including any of the damage status, a level of damage, the sensing signal, power level characteristics, time of flight characteristics, a lateral position of damage, and an axial position of damage. Data from the damage signal may also be stored locally or at the remote server or device for analysis. In this way, data can be captured for the sensor system 100 for indicating how many collisions/potential damage events the elongate structure 302 is exposed to, for example, on a daily, weekly or monthly basis.

In the illustrated example, the output signal generator 112 may reside in a housing or cap coupled to an end of the elongate structure 102, i.e. the output signal generator may be located external and local to the elongate structure 102. The output signal generator 112 may communicate with the controller 106 by wired or wireless means. In other examples, the output signal generator 112 may comprise an audible or visible signal generator located on a wall close to the sensor system. In yet further examples, the output signal generator 112 may be integrated into or positioned on the elongate structure 102.

In some examples, the controller 106 may be positioned local to the elongate structure 102. For example, the controller 106 may be housed within the elongate structure 102. In some examples, the system 100 may include the housing attachable to the exterior of the elongate structure 102 and the controller 106 may be housed in the housing. The housing may have one or more input controls. For example, the one or more input controls may include one or more function buttons, a touchscreen, switches etc. The controller 106 may be responsive to activation of the one or more input controls to activate the radiation emitter 104 and receive a sensing signal from the radiation sensor 110 or perform a calibration routine and/or reset the system 100, for example, by disabling an output signal generator 112.

In other examples, the controller 106 may be positioned remote from the housing, for example the controller may be implemented on a server or remote device. In such examples, the system 100 may further include a transceiver for transmitting raw data from the radiation sensor 110 to the controller 106.

In further examples, the controller may be realised by one or more processors local to the elongate structure 102 and one or more processors remote from the elongate structure 102, such as on a remote server or remote device. In other words, any functionality of the controller 106 described herein may be performed locally to and/or remotely from the elongate structure 102. The system 100 and/or controller 106 may include a transceiver for communicating with any remote processing device, such as a remote controller or a server.

The housing may additionally encompass the radiation emitter 104 and radiation sensor 110. In some examples, the system 100 may be realised by the housing comprising the radiation emitter, the radiation sensor, the controller 106 and optionally the output signal generator, wherein the housing is configured to be coupled to the elongate structure 102. In this way, the system 100 can be realised without encompassing the elongate structure 102.

FIG. 4A illustrates a schematic overview of another damage detection system 400 according to an embodiment of the present disclosure. Features of FIG. 4A already described above in relation to FIGS. 1A to 2B have been given corresponding reference numbers in the 400 series and will not necessarily be described again here.

The system 400 includes a plurality of sub-systems each associated with an elongate structure 402a, 402b, 402n for monitoring in an environment such as a warehouse. Each sub-system comprises a radiation emitter 404a, 404b, 404n, a radiation sensor 410a, 410b, 410c and a controller 406a, 406b, 406n. Each sub-system also comprises a transceiver (not shown) that can communicate with a server 420. The server 420 may comprise a user interface or may communicate with other devices having a user interface such as a personal mobile device or a computer. In this way, the server 420 may collect data from each of the sub-systems to monitor a damage status and potential damage at each of the associated elongate structures 402a, 402b, 402n. The system 400 may determine one or more elongate structures 402a, 402b, 402n that are particularly vulnerable to collisions as structures that have a frequency of collisions and/or frequency of near misses greater than a corresponding safety threshold. In this way, a user can analyse the monitoring data and implement changes to the structural layout (such as rearranging the layout, implementing protective measures etc) to improve the safety of the environment. In this way, an improved design of the structural layout can be achieved.

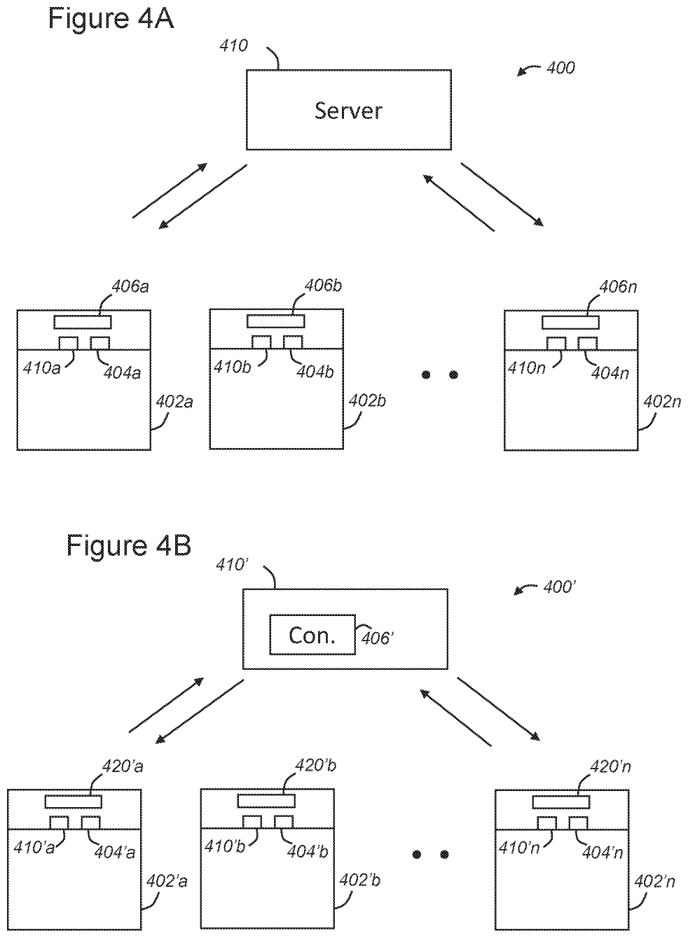

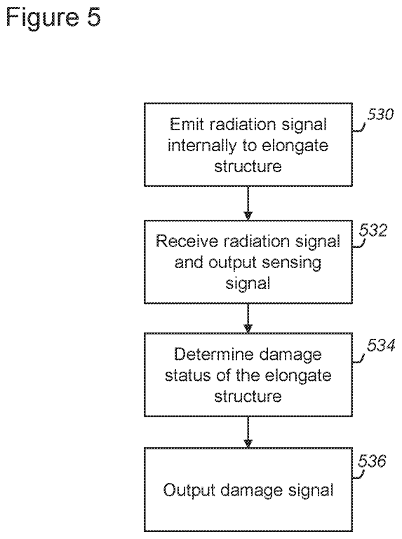

In the example, of FIG. 4A each subsystem has a dedicated local controller 406a, 406b, 406c for implementing the controller functionality as described above in relation to FIGS. 1A to 28.

In some examples, each subsystem may have a dedicated alert signal generator. In other examples, the subsystems may be communicatively coupled with a common alert signal generator. For example, two or more subsystems may be wirelessly coupled to the same audible or visible alert signal generator and/or to a common gateway that can perform some functionality of the controller 406 and/or pass information to and from the server 420.

FIG. 4B illustrates a schematic overview of a further damage detection system 400′ according to an embodiment of the present disclosure. Features of FIG. 4B already described above in relation to FIGS. 1A to 2B have been given corresponding reference numbers in the 400′ series and will not necessarily be described again here.

In this example, the system 400′ again includes a plurality of sub-systems each associated with an elongate structure 402′a, 402′b, 402′n for monitoring in an environment such as a warehouse. However, the controller 406′ is located at the server 420′ and provides the functionality described above in relation to FIGS. 1A to 2B for a plurality of the sub-systems. Each sub-system comprises a radiation emitter 404a, 404b, 404n, a radiation sensor 410a, 410b, 410c and a transceiver 420′a, 420′b, 420′c. In this example, the sub-systems act as dumb devices in that the transceivers 420′a, 420′b, 420′n transmit sensing signals from the corresponding radiation sensors 410a, 410b, 410c to the controller 406′ for processing. The transceivers 420′a, 420′b, 420′n may also receive signals from the controller 406′ for controlling the radiation emitters 404a, 404b, 404n and/or activating an alert signal generator. In this way, the functionality of the controller 406′ described in relation to FIG. 1 can be implemented at the server 420′.

FIGS. 4A and 4B respectively describe examples in which the controller functionality is implemented local to the sub-system or on the server. It will be appreciated that in other examples any elements of the functionality of the controller described in relation to FIGS. 1A to 2B may be performed local to the sub-system or remote from the sub-system on the server.

It will be appreciated that although the above description refers to an optical sensor, the disclosure is not so limited and the radiation emitter may comprise an ultrasound emitter with a corresponding ultrasound sensor. The embodiments described in relation to FIGS. 1 to 4 may be put into effect with an ultrasound based damage detection system. An ultrasonic system can be particularly advantageous for monitoring racking limbs in which fixings, such as bolts, or couplings may traverse an internal cavity of the structure. In one example, the controller may receive a reference sensing signal corresponding to the received radiation signal when the elongate structure is in a normal undamaged state. At a later time, the controller may determine a damage status based on a signal difference between the sensing signal and reference sensing signal exceeding a detection threshold. For example, the controller may determine a binary damage status as damaged or not damaged based on the signal difference. As outlined above for the optical system, the controller may monitor temporal and/or power characteristics of the sensing signal to determine further attributes of the damage status such as lateral position, axial position and level of damage.

FIG. 5 illustrates a flow diagram for a method of monitoring a condition of a safety structure or a racking limb, according to an embodiment of the present disclosure.

A first step 530 comprises emitting a radiation signal internally to, and along a length of, the elongate structure. A second step 532 comprises receiving the radiation signal and outputting a sensing signal in response. A third step 534 comprises determining a damage status of the elongate structure based on the sensing signal. A fourth step comprises outputting a damage signal representative of the damage status. One or more steps of the method 500 may be computer implemented, for example the third step 534 and the fourth step 536.

Throughout the present specification, the descriptors relating to relative orientation and position, such as “horizontal”, “vertical”, “top”, “bottom” and “side”, are used in the sense of the orientation of the damage detection system as presented in the drawings. However, such descriptors are not intended to be in any way limiting to an intended use of the described or claimed invention.

It will be appreciated that any reference to “close to”, “before”, “shortly before”, “after” “shortly after”, “higher than”, or “lower than”, etc, can refer to the parameter in question being less than or greater than a threshold value, or between two threshold values, depending upon the context.

1. A damage detection system, comprising:
an elongate structure, wherein the elongate structure is a safety structure or a racking limb;
a radiation emitter configured to emit a radiation signal internally to, and along a length of, the elongate structure;
a radiation sensor configured to receive the radiation signal and output a sensing signal in response; and
a controller configured to:
receive the sensing signal from the radiation sensor;
determine a damage status of the elongate structure based on the sensing signal; and
output a damage signal representative of the damage status.

2. The damage detection system of claim 1, wherein the radiation sensor is co-located with the radiation emitter and the radiation sensor is configured to receive the radiation signal as a reflected radiation signal.

3. The damage detection system of claim 2, wherein the radiation sensor is configured to receive the reflected radiation signal from a reference reflecting surface when the elongate structure is in an undamaged state.

4. The damage detection system of claim 3, wherein the reference reflecting surface comprises any one or more of:
a surface of a reflector positioned along a length of the elongate structure;
an end surface of the elongate structure; and
a surface of a second structure abutted to an end of the elongate structure.

5. (canceled)

6. The damage detection system of claim 3, comprising a plurality of reference reflecting surfaces corresponding to a plurality of reference reflectors positioned on an internal sidewall along a length of the elongate structure.

7. The damage detection system of claim 1, comprising a plurality of radiation emitter and radiation sensor pairs positioned successively along the length of the elongate structure, wherein:
each radiation sensor is co-located with its corresponding radiation emitter;
each radiation sensor is configured to receive a radiation signal emitted by the corresponding emitter and reflected from a corresponding reference reflection surface; and
the controller is configured to:
receive a sensing signal from each of the radiation sensors; and
determine the damage status based on the sensing signals.

8. The damage detection system of claim 1, wherein the controller is further configured to:
receive trigger signalling; and
selectively activate the radiation emitter and radiation sensor and receive the sensing signal in response to the trigger signalling.

9. The damage detection system of claim 8, wherein the trigger signalling comprises one or more of:
a periodic trigger signal for selectively activating the damage detection system according to a monitoring schedule; and
an on-demand signal from a trigger sensor responsive to:
motion of an object within a predetermined radius of the elongate structure; and/or
impact of an object with the elongate structure.

10. (canceled)

11. The damage detection system of claim 1, wherein the radiation emitter comprises an optical radiation emitter and the radiation sensor comprises an optical radiation sensor.

12. The damage detection system of claim 11, wherein the radiation emitter comprises a laser source.

13. The damage detection system of claim 1, wherein the radiation sensor comprises a radiation sensor array of a plurality of pixels, and wherein each pixel is configured to receive the radiation signal from a sub-volume of the elongate structure.

14. (canceled)

15. The damage detection system of claim 1, wherein the radiation sensor comprises a radiation sensor array of a plurality of pixels and, wherein:
each pixel is configured to output a sub-sensing signal based on a received radiation signal; and
the controller is configured to:
determine a level of damage based on a number of sub-sensing signals that exhibit a change in power and/or temporal characteristics exceeding a detection threshold; and/or
determine a lateral position of a damage site based on which sub-sensing signals exhibit a change in power and/or temporal characteristics exceeding a detection threshold.

16. The damage detection system of claim 1, wherein the damage status comprises one or more of:
a damage state of the elongate structure;
a level of damage to the elongate structure;
a lateral position of a damage site;
an axial position of a damage site; and/or
an assembly status of the elongate structure.

17. The damage detection system of claim 1, wherein the controller is configured to determine the damage status based on a change in power level characteristics and/or temporal characteristics of the sensing signal.

18. The damage detection system of claim 1, wherein the controller is configured to determine the damage status based on a signal difference between the sensing signal and a reference sensing signal corresponding to the sensing signal when the elongate structure is in an assembled and undamaged state.

19. (canceled)

20. The damage detection system of claim 1, wherein the controller is configured to determine an axial position of a damage site based on time of flight characteristics of the sensing signal.

21. (canceled)

22. The damage detection system of claim 1, wherein the controller is configured to output the damage signal by one or more of:
activating an audible visual indicator;
activating a visual indicator; and
transmitting the damage signal to an external device.

23. (canceled)

24. The damage detection system of claim 1, further comprising:
a plurality of radiation emitters, each radiation emitter configured to emit a radiation signal internally to, and along a length of, a corresponding elongate structure;
a plurality of radiation sensors each configured to receive a corresponding radiation signal and output a corresponding sensing signal;
a plurality of transceivers each coupled to a radiation sensor; and
a server configured to communicate with each of the plurality of transceivers.

25. A method of monitoring a condition of an elongate structure, wherein the elongate structure is a safety structure or a racking limb, comprising:
emitting a radiation signal internally to, and along a length of, the elongate structure;
receiving the radiation signal and outputting a sensing signal in response;
determining a damage status of the elongate structure based on the sensing signal; and
outputting a damage signal representative of the damage status.

26. The damage detection system of claim 1, wherein the radiation emitter is configured to emit the radiation signal along a cavity of the elongate structure.
